(19) United States
(12) Patent Application Publication
(10) Pub. No.: US 2011/0143275 A1
(43) Pub. Date: Jun. 16, 2011

(54) PRODUCING METHOD OF WATER DISPERSION OF POLYESTER RESIN PARTICLES, RESIN COMPOSITION, PRODUCING METHOD OF RESIN COMPOSITION AND ELECTROPHOTOGRAPHIC TONER

(75) Inventors: Hiroaki OBATA, Tokyo (JP); Mikio KOUYAMA, Tokyo (JP); Kenji HAYASHI, Tokyo (JP); Yukio HOSOYA, Tokyo (JP); Koji SHIBATA, Tokyo (JP)

(73) Assignee: KONICA MINOLTA BUSINESS TECHNOLOGIES, INC., Tokyo (JP)

(21) Appl. No.: 12/964,782

(22) Filed: Dec. 10, 2010

(30) Foreign Application Priority Data
Dec. 16, 2009 (JP) 2009-284901
Jan. 22, 2010 (JP) 2010-011654

(51) Int. Cl. G03G 9/087; C08L 67/02

(52) U.S. Cl. 430/109.4; 524/845; 524/601

(57) ABSTRACT

A method of producing a water dispersion of polyester resin particles containing the steps of: emulsifying and dispersing at least a diol, a dicarboxylic acid and at least one polycondensation catalyst selected from a surfactant catalyst and a rare earth metal catalyst in water to form an emulsified dispersion liquid; and irradiating the emulsified dispersion liquid with a microwave to conduct a polycondensation reaction, whereby polyester resin particles are produced.

### FIELD OF THE INVENTION

The present invention relates to a method of producing a water dispersion of polyester resin particles, in which an emulsified dispersion liquid formed by emulsifying and dispersing at least a diol, a dicarboxylic acid and a polycondensation catalyst in water is irradiated with a microwave to conduct a polycondensation reaction to produce polyester resin particles, a resin composition produced by employing the polyester resin particles, and an electrophotographic toner produced by employing the resin composition.

### BACKGROUND OF THE INVENTION

Polyester resins have been produced under a condition of high temperature and highly reduced pressure. Recently, a polycondensation method of a polyester resin conducted in an aqueous solution has been proposed, in which the polycondensation reaction proceeds under a pressure closer to the ordinary pressure and at a lower temperature in view of energy saving (for example, refer to Non-Patent Document 1).

Contrary to the conventional production method in which polycondensation of polyester has been carried out at a high temperature of 200-250° C. under a highly reduced pressure, in this method, the polycondensation has been known to proceed under an ordinary pressure at a temperature of 100° C. or less.

However, even in this reaction, a longer reaction time is still needed, and, thus, it has not been a fully satisfactory method.

On the other hand, a method to employ a microwave for polymerization has been proposed, which has attracted attention as a method to produce polyester in a short time with a low cost via a clean process. However, although the reaction time has been shortened, a high reaction temperature has been needed as the same as in the conventional method, and thus it has not been a fully satisfactory method.

Accordingly, a polycondensation method to obtain a polyester resin in a shorter reaction time under a moderate condition has been desired.

Non-Patent Document 1 Polymer, 2003, vol. 44, 2833-2841

### SUMMARY OD THE INVENTION

An object of the present invention is to provide a method to produce a water dispersion of polyester resin particles at a low temperature in a short time with a high thermal efficiency, a resin composition obtained by employing the polyester resin particles, and an electrophotographic toner (hereafter, merely referred to as a toner) obtained by employing the resin composition.

One of the aspects to attain the above object of the present invention is a method of producing a water dispersion of polyester resin particles comprising the steps of: emulsifying and dispersing at least a diol, a dicarboxylic acid and at least one polycondensation catalyst selected from a surfactant catalyst and a rare earth metal catalyst in water to form an emulsified dispersion liquid; and irradiating the emulsified dispersion liquid with a microwave to conduct a polycondensation reaction, whereby polyester resin particles are produced.

### BRIEF DESCRIPTION OF THE DRAWINGS

FIG. 1 is a schematic figure illustrating an example of an apparatus to produce an emulsified dispersion liquid.

FIG. 2 is a schematic figure illustrating an example of a reaction apparatus for batch processing.

FIG. 3 is a schematic figure illustrating an example of a reaction apparatus for circulate processing of an emulsified dispersion liquid.

### DESCRIPTION OF THE PREFERRED EMBODIMENTS

The above object of the present invention is achieved by the following structures.

1. A method of producing a water dispersion of polyester resin particles containing the steps of:

emulsifying and dispersing at least a diol, a dicarboxylic acid and at least one polycondensation catalyst selected from a surfactant catalyst and a rare earth metal catalyst in water to form an emulsified dispersion liquid; and

irradiating the emulsified dispersion liquid with a microwave to conduct a polycondensation reaction, whereby polyester resin particles are produced.

2. The method of Item 1, wherein the emulsified dispersion liquid is irradiated with the microwave while the emulsified dispersion liquid is circulated.

3. The method of Item 1 or 2, wherein an irradiation power of the microwave is 0.1 to 500 W/cm³.

4. The method of any one of claims 1 to 3, wherein the emulsified dispersion liquid contains a crystalline compound having a melting point of 50 to 95° C.

5. The method of any one of claims 1 to 4, wherein the polycondensation catalyst is the surfactant catalyst.

6. The method of any one of claims 1 to 5, wherein the polyester particles have a glass transition temperature of 25-90° C.

7. The method of any one of claims 1 to 5, wherein the polyester resin particles contain a non-crystalline polyester.

8. The method of any one of claims 1 to 5, wherein the polyester resin particles contain a crystalline polyester.

9. A resin composition produced by employing the polyester resin particles produced by the method of any one of claims 1 to 8.

10. A method of producing a resin composition containing the steps of:

adding a radically polymerizable monomer into the water dispersion of the polyester resin particles produced by the method of any one of claims 1 to 8; and

polymerizing the radically polymerizable monomer via seeded polymerization employing the polyester resin particles as seeds to cover surfaces of the polyester resin particles, followed by separating the obtained polyester resin particles from the water dispersion.

11. A resin composition produced by the method of claim 10.

12. An electrophotographic toner containing particles formed by aggregating and fusing the resin composition of claim 9 and a colorant under existence of an aggregating agent.

13. A method of producing a water dispersion of polyester resin particles containing the steps of:

emulsifying and dispersing at least an aliphatic diol and an aliphatic dicarboxylic acid in water containing a surfactant catalyst to form an emulsified dispersion liquid; and

irradiating the emulsified dispersion liquid with a microwave to conduct a polycondensation reaction, whereby polyester resin particles are produced.

According to the present invention, excellent effects of: low temperature, short time and high thermal efficiency, are achieved in a method of producing a water dispersion of polyester resin particles.

Further, since polyester resin particles in a state of a stable water dispersion is obtained, a resin composition and an electrophotographic toner each having a stabilized property can be provided.

In the present invention, at least one polycondensation catalyst selected from a surfactant catalyst and a rare earth metal catalyst is used in a polycondensation reaction of a diol and a dicarboxylic acid, whereby a reaction at a temperature of 100° C. or less in water becomes possible. Further, by using a microwave for a polycondensation reaction, the reaction can be proceeded while the microwave directly acts on the diol and the dicarboxylic acid, whereby it is not necessary to heat whole the water phase to a reaction temperature. As a result, a reduced loss of energy, a shortened reaction time and a high thermal efficiency have come to be attained.

In the present invention, a method of producing a water dispersion of polyester resin particles by polycondensing a diol and a dicarboxylic acid under a normal pressure at a low temperature (for example, 100° C. or less) in a short reaction time with a high thermal efficiency has been examined.

As the results of varieties of examination, it was found that a water dispersion of polyester resin particles can be produced at a low temperature in a short time with a high thermal efficiency by emulsifying and dispersing at least a diol, a dicarboxylic acid and at least one polycondensation catalyst selected from a surfactant catalyst and a rare earth metal catalyst in water to form an emulsified dispersion liquid and irradiating the emulsified dispersion liquid with a microwave to conduct a polycondensation reaction.

Hereafter, the present invention will be described in detail.

### <<Method of Producing Water Dispersion of Polyester Resin Particles>>

The method of producing water dispersion of polyester resin particles of the present invention contains:

a step of emulsifying and dispersing at least a diol, a dicarboxylic acid and at least one polycondensation catalyst selected from a surfactant catalyst and a rare earth metal catalyst in water to form an emulsified dispersion liquid; and

a step of irradiating the emulsified dispersion liquid with a microwave to conduct a polycondensation reaction to produce polyester resin particles (also referred to as a polycondensation step). The diol and the dicarboxylic acid may be added by individually dissolved in a solvent, however, it is more preferable to add as a mixed solution (hereafter, also referred to as a reaction liquid) of dissolved diol and dicarboxylic acid. The aforementioned diol may also be an aliphatic diol, and the aforementioned dicarboxylic acid may also be an aliphatic dicarboxylic acid

In the polycondensation step, the polycondensation reaction is carried out while a residence time in polycondensation reaction apparatus (H), a temperature (T), a microwave irradiation intensity (W/cm³), and a reaction time are controlled.

In the method of producing a water dispersion of polyester resin particles of the present invention, an emulsifying/dispersing apparatus in which an emulsified dispersion liquid is formed by emulsifying and dispersing at least a diol, a dicarboxylic acid and at least one polycondensation catalyst selected from a surfactant catalyst and a rare earth metal catalyst in water, and a polycondensation apparatus in which a polycondensation reaction is carried out by irradiating the emulsified dispersion liquid with a microwave are employed.

The emulsifying/dispersing apparatus is not specifically limited, and an apparatus which enables to disperse a mixed liquid containing a diol, a dicarboxylic acid and at least one polycondensation catalyst selected from a surfactant catalyst and a rare earth metal catalyst in water may be used.

The polycondensation reaction apparatus is not specifically limited as far as an emulsified dispersion liquid can be irradiated with a microwave, and a polycondensation reaction apparatus for batch processing and a polycondensation reaction apparatus for circulate processing may be cited.

The reaction vessel is preferably formed with a material which absorbs a microwave as small as possible, and does not react with raw materials used for the polycondensation reaction, for example, glass, ceramics and a fluorine-containing resin.

A microwave irradiation equipment of a power of 30-1500 W is preferably used for the irradiation with a microwave, and it is preferable that the emulsified dispersion liquid can be irradiated with an intensity of 0.1-500 W/cm³. The irradiation of the microwave may be continuous or may be intermittent.

The magnetron frequency of the microwave irradiation equipment is preferably around 300 MHz-300 GHz, and more preferably around 2450 MHz±30 MHz.

The polycondensation reaction temperature may be set up in the range where water does not boil (for example, 70-99 degrees C.).

Next, the producing facility used for the production of the dispersion liquid of polyester resin particles of the present invention will described.

### <Emulsified Dispersion Liquid Production Apparatus>

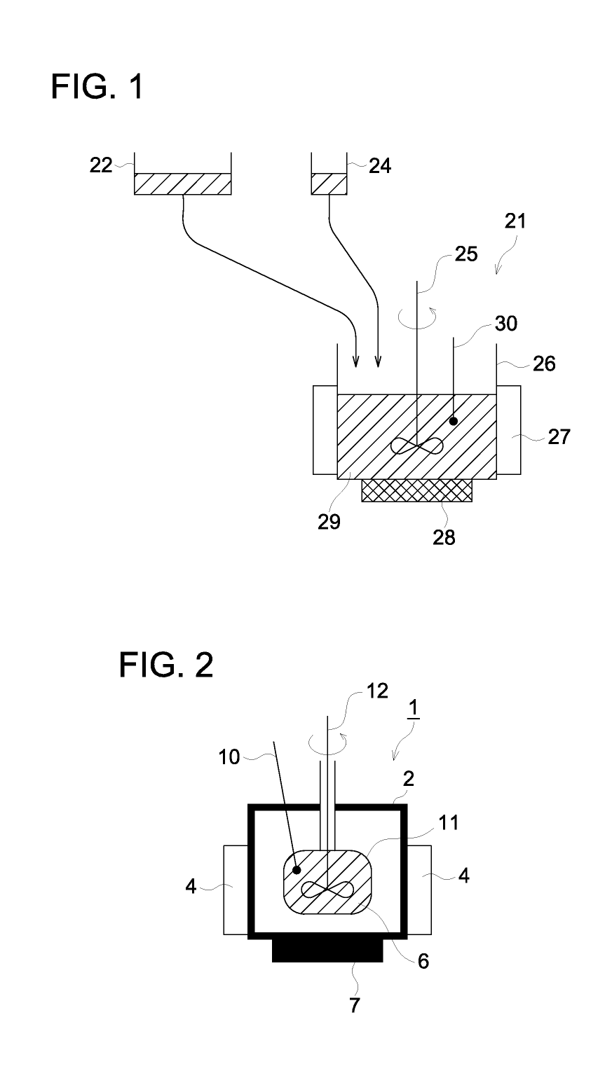

FIG. 1 is a schematic figure illustrating an example of emulsified dispersion liquid production apparatus.

In FIG. 1, 21 represents an emulsified dispersion liquid production apparatus, 22 represents a stock tank of a mixed liquid of a diol and a dicarboxylic acid, 24 represents a stock tank of a polycondensation catalyst aqueous solution, 25 represents an agitator, 26 represents a mixing vessel, 27 represents a thermostat, 28 represents an ultrasonic generator, 29 represents an emulsified dispersion liquid, and 30 represents a thermometric element.

With the emulsified dispersion liquid production apparatus of FIG. 1, first, the aqueous solution of the polycondensation catalyst is fed into the mixing vessel, and is agitated. Then, a mixed liquid of a diol and a dicarboxylic acid is supplied while the aqueous solution is agitated. Subsequently,

an emulsified dispersion liquid is produced by means of stirring or irradiation of an ultrasound. Alternatively, a mixed liquid containing a diol, a dicarboxylic acid and at least one polycondensation catalyst selected from a surfactant catalyst and a rare earth metal catalyst may be put into water, followed by producing an emulsified dispersion liquid by stirring or applying ultrasound.

When a crystalline compound is contained in the emulsified dispersion liquid, the crystalline compound is preferably added simulataneously when the diol and the dicarboxylic acid are heat melted to form a mixed liquid to form a mixed liquid also containing the crystalline compound.

Mechanical homogenizers, for example, a stirring apparatus equipped with a high-speed rotor “CLEAMIX” (produced by M Technique Co., Ltd.), an ultrasonic homogenizer, a mechanical homogenizer, a Manton-Gaulin homogenizer and a high-pressure homogenizer may be used for preparation of an emulsified dispersion liquid. Of these, an ultrasonic homogenizer is preferably used since a desired particle diameter is easily obtained.

The diameter of the emulsified droplet (also referred to as an oil droplet) of the mixed liquid of a diol and a carboxylic acid (and also a polycondensation catalyst) in the emulsified dispersion liquid is varied depending on the shape of the element and power of an ultrasonic homogenizer, the composition of the mixed liquid used for forming the oil droplets and the composition of the aqueous solution of a polycondensation catalyst. Accordingly, the treatment condition of the device for forming an emulsified dispersion liquid is suitably adjusted to obtain a desired diameter of the oil droplet.

The particle diameters of the oil droplets of the mixed liquid of a diol and a carboxylic acid in the emulsified dispersion liquid are preferably in the range of 50 nm-10 μm, and more preferably in the range of 100 nm-500 nm. The oil droplets are stably maintained in the dispersion liquid by forming the oil droplets having the diameters within the aforementioned range.

The particle diameter of the oil droplet can be measured using a commercially available apparatus for measuring a particle diameter according to a method of, for example, a light scattering method, a laser diffraction scattering method or a laser Doppler method. Examples of an apparatus for measuring a particle diameter include MICRO TRUCK MT3300 (produced by NIKKISO Co., Ltd.) and LA-750 (produced by HORIBA Ltd.), etc. can be used.

### <Polycondensation Reaction Apparatus>

Following polycondensation reaction apparatus can be used for a polycondensation reaction.

FIG. 2 is a schematic figure illustrating an example of the polycondensation reaction apparatus for batch processing.

In FIG. 2, 1 represents a polycondensation reaction apparatus, 2 represents a reflecting plate, 4 represents a microwave generator, 6 represents an emulsified dispersion liquid, 7 represents a thermostat, 10 represents a thermoscope, 11 represents a reaction vessel and 12 represents an agitator.

The polycondensation reaction apparatus for batch processing shown in FIG. 2 is an apparatus equipped with a microwave irradiation equipment and a thermostat on the outside of the reaction vessel containing emulsified dispersion liquid, and emulsified dispersion liquid can be irradiated with a microwave while the emulsified dispersion liquid is agitated.

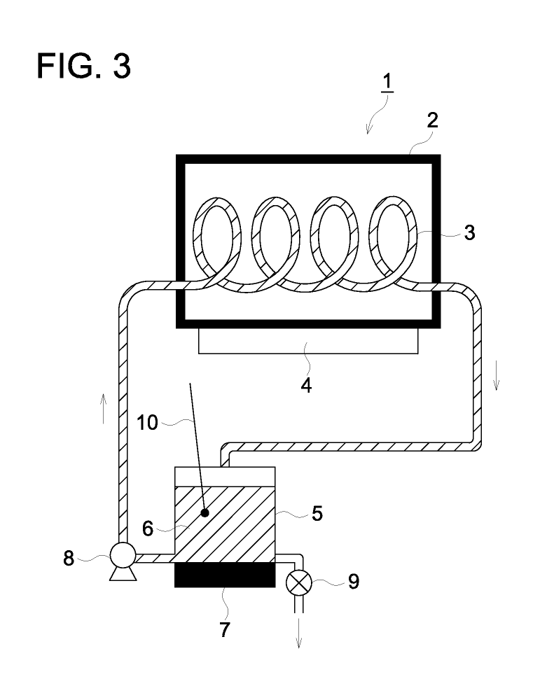

FIG. 3 is a schematic figure illustrating an example of a reaction apparatus in which an emulsified dispersion liquid is circulated.

In FIG. 3, 1 represents a polycondensation reaction apparatus, 2 represents a reflecting plate, 3 represents a helical tube, 4 represents a microwave generator, 5 represents a stock tank, 6 represents an emulsified dispersion liquid, 7 represents a thermostat, 8 represents a metering liquid pump, 9 represents an outlet valve and 10 represents a thermoscope.

The polycondensation reaction apparatus for circulate processing of an emulsified dispersion liquid shown in FIG. 3 is equipped with a microwave generator and a thermoscope on the outside of a helical tube through which an emulsified dispersion liquid can be circulated, and the emulsified dispersion liquid can be irradiated with a microwave while it is circulated.

The emulsified dispersion liquid 6 in a stock tank 5 is sent into the helical tube 3 with a liquid pump 8, where the emulsified dispersion liquid is irradiated with a microwave, and the irradiated emulsified dispersion liquid is returned to the stock tank 5. This process is continued until the completion of the reaction (until the polyester particles are formed). After the completion of the reaction, the outlet valve 9 is opened to discharge the water dispersion of the polyester resin particles.

The temperature of the emulsified dispersion liquid which is circulated through the inside of the helical tube 3 is measured by the thermoscope 10, and the liquid temperature is controlled at a preset temperature by On-OFF of the microwave generator.

When the polycondensation reaction apparatus for batch processing shown in FIG. 2 is used, an effect of reduction of the reaction time can be obtained, however, when a further time reduction and a higher thermal efficiency are considered, the polycondensation reaction apparatus for circulate processing of an emulsified dispersion liquid shown in FIG. 3 is more preferable in view of a production efficiency.

Namely, when a polycondensation reaction apparatus for circulate processing of an emulsified dispersion liquid shown in FIG. 3 is used, a scale up of the system while suppressing the production time for a desired amount of the product becomes possible, and, thus, the reduction of production time becomes possible.

An example of dimensions and conditions of a polycondensation reaction apparatus for circulate processing of an emulsified dispersion liquid will be shown below.

| | |
|---|---|
| Material of reflecting plate | Metal plate |
| Material of helical tube | Fluororesin |
| Inside diameter of helical tube | 4 mm-20 cm |
| Length of helical tube | 3-20 m |
| Circulation velocity of emulsified | 10-1000 ml/min |
| dispersion liquid | |
| Microwave irradiation intensity | 0.1-500 W/cm³ |
| Magnetron frequency of microwave | 300 MHz-300 GHz |
| Temperature | 70-99° C. |
| Reaction time | 1-6 hours |

The production efficiency as mentioned in the present invention is evaluated in terms of:

a reaction time necessary to produce a desired amount of the water dispersion of the polyester resin particles and a time necessary for repeated production;

a time necessary for cooling;

a time necessary for change over, for example, a time for washing the vessel; and

a time necessary for discharging the product.

Next, raw materials used for producing the water dispersion of the polyester resin particles of the present invention will be described.

In the method of producing a water dispersion of polyester resin particles of the present invention, a diol, a dicarboxylic acid, at least one polycondensation catalyst selected from a surfactant catalyst and a rare earth metal catalyst and, if necessary, a crystalline compound, are used as raw materials.

The aqueous phase in the present invention is an aqueous medium.

The molar ratio of diol and dicarboxylic acid used as raw materials is not specifically limited, however, in order to avoid separation of a surplus material after the reaction, and to avoid ejection of a large amount of waste material, it is preferable to set the molar ratio to 1:1.

### (Diol)

Examples of a diol include ethylene glycol, propylene glycol, 1,3-butane diol, 1,4-butane diol, 1,5-pentane diol, 1,6-hexane diol, 1,7-heptane diol, 1,8-octane dial, 1,9-nonane diol, 1,10-decane diol, 1,12-dodecane diol, trimethylolpropane, neopentyl glycol and methylpentane diol. Further, alicyclic diols such as cyclohexane dial and cyclohexanedimethanol, and aromatic diols such as hydrogenated bisphenol A, bisphenol A-ethyleneoxide adduct and bisphenol A-propyleneoxide adduct may be cited. In order to obtain a crystalline polyester, an aliphatic diol containing an alkylene group having 2-20 carbon atoms are preferably used among these compounds.

Further, in order to introduce a cross linking structure or a branched structure, a polyalcohol of tervalent or more, for example, glycerin, trimethylol propane and pentaerythritol may be used in combination.

### (Dicarboxylic Acid)

Examples of a dicarboxylic acid include terephthalic acid, isophthalic acid, orthophthalic acid, t-butylisophthalic acid, 5-sulfoisophthalic acid, 2,6-naphthalenedicarboxylic acid and 4,4′-biphenyldicarboxylic acid. Specifically preferable are terephthalic acid, isophthalic acid, t-butylisophthalic acid alkyl esters thereof.

Examples of an aliphatic dicarboxylic acid include oxalic acid, malonic acid, succinic acid, glutaric acid, adipic acid, pimelic acid, suberic acid, azelaic acid, sebacic acid, 1,9-nonanedicarboxylic acid, 1,10-decanedicarboxylic acid, 1,11-undecanedicarboxylic acid, 1,12-dodecanedicarboxylic acid, 1,13-tridecanedicarboxylic acid, 1,14-tetra decanedicarboxylic acid, 1,16-hexadecanedicarboxylic acid, 1,18-octadecanedicarboxylic acid, and a lower alkyl ester and an acid anhydride thereof.

Also, fumaric acid, maleic acid and 1,4-cyclohexane dicarboxylic acid are usable.

In order to improve the compatibility, a dicarboxylic acid having a long chain alkyl group as a side chain of such as, hexenyl succinic acid, dodecenyl succinic acid or octadodecenyl succinic acid may be used.

Further, in order to obtain a crystalline polyester, an aliphatic dicarboxylic acid containing an alkylene group having 2-20 carbon atoms are preferably used among these compounds.

Trimellitic acid, anhydrous trimellitic acid or 1,3,5 benzene tricarboxylic acid can also be used to increase an acid value or to introduce a cross-linking structure, if needed.

The polyester constituting the polyester resin particles of the present invention may be a crystalline polyester or a non-crystalline polyester.

A crystalline resin means a resin exhibiting an apparent thermal absorption peak in differential scanning calorimetry (DSC), instead of a stepwise thermal absorption behavior. The above mentioned “apparent thermal absorption peak” means that the half-value width of the thermal absorption peak when measured at a temperature increasing rate of 10° C./min in the differential scanning calorimetry (DSC) is 15° C. or less. A crystalline polyester may be cited as an example of a crystalline resin. A non-crystalline resin means a resin which does not exhibit an apparent thermal absorption peak in aforementioned DSC and a resin other than the crystalline resin. Examples of a non-crystalline resin include a styrene resin, a (meth)acrylic resin, a styrene-(meth)acryl copolymer resin and a non-crystalline polyester resin.

### <<Polycondensation Catalyst>>

In the present invention, at least one polycondensation catalyst selected from a surfactant catalyst and a rare earth metal catalyst is used.

When an aqueous solution of at least one polycondensation catalyst selected from a surfactant catalyst and a rare earth metal catalyst or a rare earth metal catalyst dispersed in water together with a diol and a dicarboxylic acid is used in the polycondensation reaction of a diol and a dicarboxylic acid, the reaction can be conducted at a low temperature (for example, 70-99° C.).

Since the reaction can be carried out at a temperature lower than the boiling point of water, it has become possible to prepare an emulsified dispersion liquid in which a diol and a carboxylic acid are dispersed as oil droplets in water (or in an aqueous phase) and to irradiate the emulsified dispersion with a microwave to produce a water dispersion of polyester resin particles.

As a surfactant catalyst (or a surfactant-containing catalyst), strong acids each having an effect of surface activity may be cited. Examples of such a compound include: an alkylbenzene sulfonic acid such as dodecylbenzenesulfonic acid, isopropylbenzenesulfonic acid, p-toluenesulfonic acid and camphor sulfonic acid; a sulfuric acid ester of a higher aliphatic acid such as an alkyl sulfonic acid, an alkyl disulfonic acid, an alkylphenol sulfonic acid, an alkyl naphthalene sulfonic acid, an alkyl tetralin sulfonic acid, an alkyl allyl sulfonic acid, a petroleum sulfonic acid, an alkyl benzimidazole sulfonic acid, a higher alcohol ether sulfonic acid, an alkyl diphenyl sulfonic acid, a mono-butylphenyl phenol sulfuric acid and a dodecyl sulfuric acid; a higher alcohol sulfate; a higher alcohol ethereal sulfate; a higher aliphatic acid amide alkylation sulfate; a higher aliphatic acid amide alkylol sulfate; a naphthenyl alcohol sulfuric acid; a sulfated fat; a sulfo succinate; various fatty acids; a sulfonated higher fatty acid; a higher alkyl phosphoric ester; a resin acid; a naphthenic acid; a niobic acid and salt compounds thereof. These compounds may be used in combination. However, the present invention is not limited thereto.

As a surfactant catalyst used preferably, for example, dodecylbenzenesulfonic acid, isopropylbenzenesulfonic acid, p-toluenesulfonic acid and camphor sulfonic acid may be cited.

### (Rare Earth Metal Catalyst)

As a rare earth metal catalyst (also referred to as a rare earth metal-containing catalyst), compounds which contains a rare earth metal in the structure is used.

Example of a rare earth metal include scandium (Sc), yttrium (Y), lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb) and ruthenium (Lu).

As a structure of a rare earth metal catalyst, those having structures of an alkylbenzene sulfonate, a sulfuric acid alkyl ester salt and a triflate are effectively used. As a triflate, X(OSO₂CF₃)₃ is preferably cited. In the above formula, X represents a rare earth metal, and, for example, scandium (Sc), yttrium (Y), ytterbium (Yb) and samarium (Sm) are preferably used.

Also, for example, lanthanide triflate is preferable. Lanthanide triflate has been described in detail in “Society of Synthetic Organic Chemistry, Japan”, Vol. 53, No. 5, pages 44-54.

Among these compounds, as a preferably used rare earth metal catalyst, for example, those having Y, Sc, Yb or Sm in the structure are specifically preferable. As specific compounds, for example, scandium (III) triflimide and scandium (III) triflate may be cited.

The addition amount of a surfactant catalyst or a rare earth metal catalyst is preferably 0.1-100,000 ppm and more preferably 0.1-80,000 ppm based on the total amount of the diol and the carboxylic acid. The catalysts may be used alone or in combination of plural kinds.

It is more preferable to used a surfactant catalyst in view of the effectiveness to reduce the reaction time and a cost. Also, a surfactant catalyst is preferable since it has a function to pump out the water formed in the polycondensation reaction to outside of the reaction system.

### <<Crystalline Compound>>

A crystalline compound is preferably added and mixed with a diol and a carboxylic acid when a polycondensation reaction is carried out. When a crystalline compound is mixed, it is preferably melted. Examples of a crystalline compound (hereafter, also referred to as a wax) include: hydrocarbon waxes such as a low molecular weight polyethylene wax, a low molecular weight polypropylene wax, a Fischer Tropsch wax, a microcrystalline wax and a paraffin wax; and ester waxes such as a carnauba wax, pentaerythritol tetrabehenate, behenyl behenate and behenyl citrate. These waxes may be used alone or in combination of two or more kinds.

The content of a crystalline compound is preferably 2-20% by mass, more preferably 3-18% by mass, and further more preferably 4-15% by mass based on the total mass of the polyester resin particles.

The melting point of a crystalline compound is preferably 50 95° C. in view of a low temperature fixing property and a releasing property as an electrophotographic toner.

Next, the properties of the polyester resin particle will be described.

The concentration of the polyester resin particles in the water dispersion of a polyester resin particles is not specifically limited, however, it is preferably 5-50 mass parts in 100 mass parts of water, in view of the polycondensation reaction and handling easiness.

### (Weight Average Molecular Weight, Number Average Molecular Weight and Ratio of Weight Average Molecular Weight to Number Average Molecular Weight)

In the present invention, crystalline polyester having a weight average molecular weight (Mw) of around 1000 to 20,000 is preferably produced. As a ratio (Mw/Mn) of weight average molecular weight (Mw) to number average molecular weight (Mn), 5.0 or less is preferable.

The molecular weight of a polyester resin particle can measure tetrahydrofuran (THF) by the gel permeation chromatography graph (GPC) method used as a column solvent.

The method of determination of the molecular weight of the polyester resin particle using GPC (gel permeation chromatography) is as follows. First, the sample is dissolved in tetrahydrofuran to a density of 1 mg/ml. Dissolution is carried out at room temperature over five minutes, employing an ultrasonic homogenizer. Subsequently, the resulting solution is passed through membrane filters of a pore size of 0.2 μm followed by injection of 10 μl of the sample solution into the measuring apparatus. An example of the measuring condition in GPC is described below.

Apparatus: HLC-8220 (produced by Tosoh Corp.)

Column: a triple column of TSKguardcolumn+TSKgelSuperHZM-M (produced by Tosoh Corp.)

Column temperature: 40° C.

Solvent: tetrahydrofuran

Flow rate: 0.2 ml/minute

Detector: refractive index (RI) detector

With regard to measurement of the weight average molecular weight of the sample, the molecular weight distribution of the sample is calculated employing a calibration curve measured employing monodispersed polystyrene standard particles. Ten polystyrenes are used for the determination of the calibration curve.

### (Particle Diameter of Polyester Resin Particles)

In the present invention, polyester resin particles having a volume median diameter (D₅₀) of 50 nm-10 μm are preferably produced.

Here, the volume median diameter (D₅₀) means a diameter of the resin particle at which the count number (an accumulated number) corresponds to 50% of the total number of the particles when the number of particles is counted in an increasing order or a decreasing order of the particle diameter.

The volume median diameter (D₅₀) of the polyester resin particles can be measured by using MULTISIZER 3 (produced by BECKMAN COULTER, Inc.) connected with a data processing computer system (produced by BECKMAN COULTER, Inc.).

The instrument and the measurement condition are chosen so that the measuring range is suitable for the obtained resin particles.

The producing apparatus for circulate processing of an emulsified dispersion liquid is suitable for obtaining resin particles having the aforementioned volume median diameter (D₅₀).

The polyester resin particles of the present invention preferably has a glass transition temperature (Tg) of 25-90° C.

Next, a resin composition obtained from the water dispersion of the polyester rein particles of the present invention and an electrophotographic toner obtained by employing the resin composition will be described.

### <<Resin Composition>>

The resin composition according to the present invention is the polyester resin particles obtained by separating the polyester resin particles from the water dispersion of the polyester resin particles.

The resin composition may contain a crystalline compound in the resin particles, if necessary.

The resin composition may also be composite resin particles covered with a resin obtained by polymerizing a radically polymerizable monomer by adding a radically polymerizable monomer into a water dispersion of polyester resin particles followed by conducting seed polymerization employing the polyester resin particles as seeds.

This resin composition can be preferably used as, for example, a resin for a toner or for a paint.

### <<Toner>>

The electrophotographic toner of the present invention can be produced by aggregating/heat fusing the aforementioned resin composition and a colorant under existence of an aggregating agent.

A toner having an excellent low temperature fixing property can be obtained by employing the resin composition produced from the water dispersion of the polyester resin particles of the present invention.

Further, when employing a resin composition produced from a water dispersion of polyester resin particles obtained by carrying out polycondensation of an emulsified dispersion liquid containing a diol, a dicarboxylic acid and further a crystalline compound as a constituting resin of a toner, the crystalline compound is effectively taken in the toner particle without being detached from the toner particle.

Each process of producing the electrophotographic toner will be described below.

### <Aggregating Process>

In the aggregating process, a dispersion liquid for aggregation (also referred to as an aggregation dispersion) is prepared by mixing the aforementioned water dispersion of the resin composition, colorant particles and, if desired, wax particles, charge control agent particles and particles of other toner constituent. Then, the polyester resin particles, colorant particles and so on are subjected to aggregation and fusion to prepare a dispersion liquid of colorant particles.

In more detail, a salting-out treatment is conducted by adding an aggregation agent having a concentration of at least the critical aggregation concentration into the aggregation dispersion, and simultaneously stirring them in a reaction apparatus equipped with stirring blades described later in a stirring mechanism, while the heat-fusing treatment is conducted at a temperature higher than the glass transition point of the resin composition. Then, while forming aggregated particles, the particle diameter is allowed to gradually increase, when the particle diameter reaches the desired value, particle growth is stopped by adding a relatively large amount of water, and the resulting particle surface is smoothed via further heating and stirring, to control the shape, whereby colored particles are formed.

The aggregation agent to be employed is not specifically limited, but aggregation agents selected from metal salts are preferable. Examples of specific metal salts include a salt of monovalent metal such as sodium, potassium, or lithium, a salt of divalent metal such as calcium, magnesium, or copper, and a salt of trivalent metal such as aluminum and the like. Examples of specific salts include sodium chloride, potassium chloride, lithium chloride, calcium chloride, magnesium chloride, zinc chloride, copper sulfate, magnesium sulfate, and manganese sulfate. Of these, a salt of divalent metal is specifically preferable. In the case of using the salt of divalent metal, the aggregation process can be achieved with a smaller amount of aggregation agent. These can also be used singly or in combination of at least two kinds.

In the aggregation process, the period of standing time after addition of the aggregation agent (or the time before start heating) is preferably as short as possible. Namely, it is preferable that the aggregation dispersion is heated as quickly as possible after addition of the aggregation agent, and then heated to at least the glass transition temperature of the resin composition or higher. The reason why this is most effective has not yet been clear. However, problems may occur, in which the state of aggregated particles varies depending on the elapsed standing time, whereby an unstable particle diameter distribution of the resulting toner particles possibly occurs and the surface condition tend to fluctuate. The standing time is commonly within 30 minutes, and is preferably within 10 minutes. The temperature, at which the aggregation agent is added, is not specifically limited, but is preferably equal to or lower than the glass transition temperature of the polyester resin particles.

Further, it is preferred that in the aggregation process, the temperature is quickly increased via heating, and the rate of temperature increase is preferably 1° C./minute or more. There is specifically no upper limit in a rate of temperature increase, but the rate of temperature increase is preferably at most 15° C./minute in view of inhibiting coarse grain formation caused by the accelerated fusing process. Further, after the aggregation dispersion is heated to the glass transition temperature or more, it is important to continuously conduct the fusing process while maintaining the aggregation dispersion temperature for a prescribed duration. According to this procedure, the step of growing colored particles (namely, aggregation of the polyester resin particles and the colorant particles) and the step of fusing (namely, disappearance of boundaries between particles) can be effectively accelerated, whereby durability of the resulting toner can be enhanced.

Carbon black, magnetic materials, dyes and pigments can optionally be employed as colorants, and, for example, channel black, furnace black, acetylene black, thermal black or lamp black can be used as carbon black. Also employed can be: ferromagnetic metals such as iron, nickel and cobalt; alloys containing these metals; ferromagnetic compounds such as ferrite or magnetite; alloys each of which does not contain a ferromagnetic metal but exhibits a ferromagnetic property when heat treated, such as so-called Heusler alloys, for example, a manganese-copper-aluminum alloy and a manganese-copper-tin alloy; and chromium dioxide.

Examples of a dye include: C.I. Solvent Red 1, the same 49, the same 52, the same 58, the same 63, the same 111, and the same 122; C.I. Solvent Yellow 19, the same 44, the same 77, the same 79, the same 81, the same 82, the same 93, the same 98, the same 103, the same 104, the same 112, and the same 162; and C.I. Solvent Blue 25, the same 36, the same 60, the same 70, the same 93, the same 95, and, further, mixtures thereof. Examples of a pigment include: C.I. Pigment Red 5, the same 48:1, the same 53:1, the same 57:1, the same 122, the same 139, the same 144, the same 149, the same 166, the same 177, the same 178, and the same 222; C.I. Pigment Orange 31, and the same 43; C.I. Pigment Yellow 14, the same 17, the same 93, the same 94, the same 138, the same 155, the same 180 and the same 185; C.I. Pigment Green 7; C.I. Pigment Blue 15:3 and the same 60; and mixtures thereof. The number average primary particle diameter varies widely depending on the type, but is preferably 10-200 nm.

Employed as charge control agents constituting charge control agent particles may also be various types of those which are known in the art and which can be dispersed in an aqueous medium. Specifically listed are a nigrosine based dye, a metal salt of naphthenic acid or higher fatty acid, an alkoxylated amines, a quaternary ammonium salt, an azo based metal complexe and a salicylic acid metal salt or a metal complexe thereof.

Further, it is preferable that the number average primary particle diameter of the charge control agent particles is roughly between 10 and 500 nm in the dispersed state.

The colorant particle dispersion can be prepared by dispersing colorants in an aqueous medium. The dispersion process of colorants is preferably conducted with the surfactant concentration being not less than the critical micelle concentration, since colorants are evenly dispersed. As a disperser used for the dispersion treatment of a colorant, a well-known disperser may be used. As a surfactant usable for the dispersion, a well-known surfactant may be used.

In the case of toner composed of toner particles prepared via aggregation and fusion of a resin composition and a colorant, it is also possible to form toner having a prescribed shape factor and a highly uniform shape distribution, by using stirring blades and a stirring tank which can create a flow in a reaction apparatus to be a laminar flow and can uniform inner temperature distribution, and by controlling the temperature, the number of revolution of the stirring blades and the duration of the aggregation process. The reason why toner having a highly uniform shape distribution can be produced is as follows: when the aggregation process is conducted in the field where a laminar flow has been formed, intensive stress is not applied to aggregated particles to which aggregation and fusion have been accelerated, and temperature distribution in the stirring tank is uniform in the accelerated laminar flow, whereby the shape distribution of aggregated particles becomes presumably uniformized. Further, the aggregated particles are gradually changed into spheres via the shape controlling process of heating and stirring, thus, the resulting colored particle shape can be optionally controlled.

It is preferable is to use the stirring tank equipped with the stirring blade, which has been used for producing the toner constituted of the toner particles composed of the colored particles obtained by aggregating and fusing the resin composition and the colorant.

### <Filtering/Washing Process>

In the filtrating/washing process, carried out are a filtrating process in which the colored particles are separated from the colored particle dispersion obtained by the above aggregation process by filtering, and a washing process in which adhered materials such as surfactants and aggregation agents are removed from filtrated colored particles (also known as caked aggregation). Herein, filtrating treatment methods are not specifically limited, but include, for example, a centrifugal separation method, a vacuum filtration method employing a Buchner funnel and a filtration method employing a filter press.

### <Drying Process>

The washed colored particles are then subjected to a drying process. Provided as a dryer used in this process is a spray dryer, a vacuum-freeze dryer or a vacuum dryer. The moisture content of dried colored particles is preferably 1.0% by mass or less, but more preferably 0.5% by mass or less.

Further, when dried colored particles aggregate due to weak inter-particle attractive forces, aggregates may be subjected to pulverization treatment. Herein, employed as pulverization devices may be mechanical pulverization devices such as a jet mill, a HENSCHEL MIXER, a coffee mill and a food processor.

### <External Additive Addition Process>

This external additive addition process is to be carried out to improve fluidity, chargeability, and the cleaning property to dried colored particles. Provided as devices to add external additives, may be various types of commonly known mixing devices such as a tubular mixer, a HENSCHEL MIXER, a Nauter mixer and a V-type mixer.

External additives are not specifically limited, and various inorganic particles, organic particles, and lubricants can be utilized. Inorganic oxide particles such as silica, titania and alumina are preferably employed as inorganic particles, and further these inorganic particles are preferably subjected to hydrophobic treatment employing a silane coupling agent or a titanium coupling agent.

The addition amount of the external additive is 0.1-5.0% by mass and preferably 0.5-4.0% by mass based on the mass of the toner. The external additive may also be used in combination with various appropriate substances.

### EXAMPLES

The embodiments of the present invention will be described concretely, however, the present invention is not limited thereto.

### <<Production of Water Dispersion of Polyester Resin Particles>>

The water dispersion of the polyester resin particles (also referred to as polyester resin particles water dispersion) was produced as follows.

### <Production of Polyester Resin Particles Water Dispersion 1>

### (1) Preparation of Surfactant Catalyst Aqueous Solution

The following materials were mixed and dissolved, and a surfactant solution was prepared.

| | |
|---|---|
| Dodecylbenzenesulfonic acid | 1.7 g |
| | (30000 ppm based on the |
| | mass of reaction liquid) |
| Pure water | 200 g |

### (2) Preparation of Mixed Liquid

The following materials were heat melted at 130° C. to form homogeneous “mixed solution 1”.

| | |
|---|---|
| 1,9-nonanediol | 22 g |
| 1,10-decanedicarboxylic acid | 32 g |

### (3) Preparation of Emulsified Dispersion Liquid

Using the aforementioned emulsified dispersion liquid production apparatus illustrated in FIG. 1, the surfactant catalyst aqueous solution was fed in the mixing vessel, and the surfactant catalyst aqueous solution was heated to 80° C. Then, the mixed liquid 1 was mixed while the surfactant catalyst aqueous solution was further agitated. Ultrasound was applied to the mixed liquid using an ultrasonic homogenizer (produced by NIPPON SEMI Co., Ltd.) to prepare emulsified dispersion liquid

### (4) Polycondensation of Emulsified Dispersion Liquid

Using the polycondensation apparatus for batch processing illustrated in FIG. 2, a microwave was applied under the following condition to carry out polycondensation of emulsified dispersion liquid 1, whereby polyester resin particles water dispersion 1 was obtained.

### Setting Conditions

| | | |
|---|---|---|
| Maximum intensity of microwave irradiation | 10 | W/cm³ |
| Magnetron frequency of microwave | 2450 | MHz |
| Polymerization temperature | 80° | C. |
| Reaction time | 3 | hours |

The polymerization temperature of the emulsified dispersion liquid was maintained by the ON-OFF of the microwave irradiation.

The prepared polyester resin particles were collected and the molecular weight of the polyester resin was determined by means of gel permeation chromatography (GPC). Further, the melting point was measured using a differential scanning calorimeter (DSC) equipped with a balance, and the volume average particle diameter was determined using Microtrac UPA150 (produced by NIKKISO Co., Ltd.)

| | |
|---|---|
| Weight average molecular weight of polyester resin | 12,500 |
| Melting point of polyester resin | 68° C. |
| Volume average particle diameter of polyester resin | 310 nm |
| particles | |

It took finally 14 hours to obtain a water dispersion of a desired amount of polyester resin particles (150 g) by repeating these procedures 3 times including the procedure for change over, for example, washing the vessel.

### <Production of Polyester Resin Particles Water Dispersion 2>

An emulsified dispersion liquid was prepared in the same manner as the preparation method of the emulsified dispersion liquid employed for the production of polyester resin particles water dispersion 1.

### (1) Preparation of Surfactant Catalyst Aqueous Solution

The following materials were mixed and dissolved, and a surfactant solution was prepared.

| | |
|---|---|
| Dodecylbenzenesulfonic acid | 5.1 g |
| Pure water | 600 g |

### (2) Preparation of Mixed Liquid

The following materials were heat melted at 130° C. to form homogeneous “mixed solution 2”.

| | |
|---|---|
| 1,9-nonanediol | 66 g |
| 1,10-decanedicarboxylic acid | 96 g |

### (3) Preparation of Emulsified Dispersion Liquid

Using the aforementioned emulsified dispersion liquid production apparatus illustrated in FIG. 1, the surfactant catalyst aqueous solution was fed in the mixing vessel, and the surfactant catalyst aqueous solution was heated to 80° C. Then, the mixed liquid 2 was mixed while the surfactant catalyst aqueous solution was further agitated. Ultrasound was applied to the mixed liquid using an ultrasonic homogenizer (produced by NIPPON SEIKI Co., Ltd.) to prepare emulsified dispersion liquid 2.

### (4) Polycondensation of Emulsified Dispersion Liquid

Using the polycondensation apparatus for circulate processing illustrated in FIG. 3, a microwave was applied to the emulsified dispersion liquid 2 under the following condition while the emulsified dispersion liquid 2 was circulated to carry out polycondensation of emulsified dispersion liquid 2, whereby polyester resin particles water dispersion 2 was obtained. Setting conditions for the apparatus shown in FIG. 3.

| | | |
|---|---|---|
| Inner diameter | 5 | mm |
| Length | 5 | m |
| Amount of circulating liquid | 20 | ml/nim |
| Maximum intensity of microwave irradiation | 10 | W/cm³ |
| Magnetron frequency of microwave | 2450 | MHz |
| Polymerization temperature | 80° | C. |
| Reaction time | 9 | hours |

The polymerization temperature of the emulsified dispersion liquid was maintained by the ON-OFF of the microwave irradiation. The circulation was carried out for 9 hours.

The reaction was stopped 9 hours afterward and the reaction was ended.

The weight average molecular weight of the obtained polyester resin, the melting point, and the volume average particle diameter were measured.

| | |
|---|---|
| Weight average molecular weight of polyester resin | 11,600 |
| Melting point of polyester resin | 68° C. |
| Volume average particle diameter of polyester resin | 298 nm |
| particles | |

### <Production of Polyester Resin Particles Water Dispersions 3>

The polyester resin particles water dispersions 3 was produced in the same manner as the production of the polyester resin particles water dispersions 2 except that the maximum intensity of microwave irradiation was changed from 10 W/cm³ to 1 W/cm³. The weight average molecular weight of the obtained polyester resin, the melting point, and the volume average particle diameter were measured in the same manner as above.

| | |
|---|---|
| Weight average molecular weight of polyester resin | 10,200 |
| Melting point of polyester resin | 67° C. |
| Volume average particle diameter of polyester resin | 308 nm |
| particles | |

### <Production of Polyester Resin Particles Water Dispersion 4>

The polyester resin particles water dispersion 4 was produced in the same manner as the production of the polyester resin particles water dispersions 2 except that the maximum intensity of microwave irradiation was changed from 10 W/cm³ to 50 W/cm³. The weight average molecular weight of the obtained polyester resin, the melting point, and the volume average particle diameter were measured in the same manner as above.

| | |
|---|---|
| Weight average molecular weight of polyester resin | 11,200 |
| Melting point of polyester resin | 66° C. |
| Volume average particle diameter of polyester resin | 304 nm |
| particles | |

### <Production of Polyester Resin Particles Water Dispersion 5>

### (1) Preparation of Surfactant Catalyst Aqueous Solution

The following materials were mixed and dissolved, and a surfactant solution was prepared.

| | |
|---|---|
| Dodecylbenzenesulfonic acid | 5.1 g |
| Pure water | 600 g |

### (2) Preparation of Mixed Liquid

The following materials were heat melted at 130° C. to form homogeneous “mixed solution 4”.

| | |
|---|---|
| 1,12-dodecanediol | 84 g |
| Azelaic acid | 78 g |

### (3) Preparation of Emulsified Dispersion Liquid

Emulsified dispersion liquid 4 was prepared in the same manner as the preparation of mulsified dispersion liquid 2.

### (4) Polycondensation of Emulsified Dispersion Liquid

Polyester resin particles water dispersion 4 was produced in the same manner as the production of polyester resin particles water dispersion 2 except that the emulsified dispersion liquid 2 used in the production of polyester resin particles water dispersion 2 was changed to above mentioned emulsified dispersion liquid 4. The weight average molecular weight of the obtained polyester resin, the melting point, and the volume average particle diameter were measured.

| | |
|---|---|
| Weight average molecular weight of polyester resin | 10,300 |
| Melting point of polyester resin | 66° C. |
| Volume average particle diameter of polyester resin | 324 nm |
| particles | |

### <Production of Polyester Resin Particles Water Dispersion 6>

### (1) Preparation of Surfactant Catalyst Aqueous Solution

The following materials were mixed and dissolved, and a surfactant solution 6 was prepared.

| | |
|---|---|
| p-toluenesulfonic acid | 5.1 g |
| Pure water | 600 g |

### (2) Preparation of Mixed Liquid

The following materials were heat melted at 130° C. to form homogeneous “mixed solution 6”.

| | |
|---|---|
| 1,9-nonanediol | 66 g |
| 1,10-decanedicarboxylic acid | 96 g |

### (3) Preparation of Emulsified Dispersion Liquid

Emulsified dispersion liquid 6 was prepared in the same manner as the preparation of the emulsified dispersion liquid 2.

### (4) Polycondensation of Emulsified Dispersion Liquid

Polyester resin particles water dispersion 6 was produced in the same manner as the production of polyester resin particles water dispersion 2 except that the emulsified dispersion liquid 2 used in the production of polyester resin particles water dispersion 2 was changed to above mentioned emulsified dispersion liquid 6. The weight average molecular weight of the obtained polyester resin, the melting point, and the volume average particle diameter were measured.

| | |
|---|---|
| Weight average molecular weight of polyester resin | 9,800 |
| Melting point of polyester resin | 67° C. |
| Volume average particle diameter of polyester resin | 288 nm |
| particles | |

### <Production of Polyester Resin Particles Water Dispersion 7>

### (1) Preparation of Surfactant Catalyst Aqueous Solution

The following materials were mixed and dissolved, and a surfactant solution 7 was prepared.

| | |
|---|---|
| Dodecylbenzenesulfonic acid | 5.1 g |
| Pure water | 600 g |

### (2) Preparation of Mixed Liquid

The following materials were heat melted at 130° C. to form homogeneous “mixed solution 7”.

| | |
|---|---|
| 1,9-nonanediol | 66 g |
| 1,10-decanedicarboxylic acid | 96 g |
| Behenyl behenate | 66 g |

### (3) Preparation of Emulsified Dispersion Liquid

Emulsified dispersion liquid 7 was prepared in the same manner as the preparation of mulsified dispersion liquid 2.

### (4) Polycondensation of Emulsified Dispersion Liquid

Polyester resin particles water dispersion 7 was produced in the same manner as the production of polyester resin particles water dispersion 2 except that the emulsified dispersion liquid 2 used in the production of polyester resin particles water dispersion 2 was changed to above mentioned emulsified dispersion liquid 7. The weight average molecular weight of the obtained polyester resin, the melting point, and the volume average particle diameter were measured.

| | |
|---|---|
| Weight average molecular weight of polyester resin | 11,180 |
| Melting point of polyester resin | 66° C. |
| Volume average particle diameter of polyester resin | 332 nm |
| particles | |

### <Production of Polyester Resin Particles Water Dispersion 8>

### (1) Preparation of Surfactant Catalyst Aqueous Solution

The following materials were mixed and dissolved, and a surfactant solution 8 was prepared.

| | |
|---|---|
| Dodecylbenzenesulfonic acid | 4.3 g |
| Pure water | 600 g |

### (2) Preparation of Mixed Liquid

The following materials were heat melted at 130° C. to form homogeneous “mixed solution 8”.

| | |
|---|---|
| (1 mole ethylene oxide)bisphenol A | 105 g |
| 1,4-cyclohexanedicarboxylic acid | 57 g |

### (3) Preparation of Emulsified Dispersion Liquid

Emulsified dispersion liquid 8 was prepared in the same manner as the preparation of the mulsified dispersion liquid 2.

### (4) Polycondensation of Emulsified Dispersion Liquid

Polyester resin particles water dispersion 8 was produced in the same manner as the production of polyester resin particles water dispersion 2 except that the emulsified dispersion liquid 2 used in the production of polyester resin particles water dispersion 2 was changed to above mentioned emulsified dispersion liquid 8. The weight average molecular weight of the obtained polyester resin, the melting point, and the volume average particle diameter were measured.

| | |
|---|---|
| Weight average molecular weight of polyester resin | 15,800 |
| Tg of polyester resin | 54° C. |
| Volume average particle diameter of polyester resin | 287 nm |
| particles | |

### <Production of Polyester Resin Particles Water Dispersion 9>

### (1) Preparation of Mixed Liquid

The following materials were heat melted at 130° C. to form homogeneous “mixed solution 9”.

| | |
|---|---|
| (1 mole ethylene oxide)bisphenol A | 105 g |
| 1,4-cyclohexanedicarboxylic acid | 96 g |
| Scandium(III) triflimide | 118 g |

### (2) Preparation of Emulsified Dispersion Liquid

Six hundreds grams of pure water was kept in a thermostat oven to keep warming at 95° C. Then, the mixed liquid 9 was mixed while the pure water was further agitated. Ultrasound was applied to the mixed liquid using an ultrasonic homogenizer (produced by NIPPON SEIKI Co., Ltd.) to prepare emulsified dispersion liquid 9.

### (3) Polycondensation of Emulsified Dispersion Liquid

Polyester resin particles water dispersion 9 was produced in the same manner as the production of polyester resin particles water dispersion 2 except that the emulsified dispersion liquid 2 used in the production of polyester resin particles water dispersion 2 was changed to above mentioned emulsified dispersion liquid 9. The weight average molecular weight of the obtained polyester resin, the melting point, and the volume average particle diameter were measured.

| | |
|---|---|
| Weight average molecular weight of polyester resin | 13,500 |
| Tg of polyester resin | 56° C. |
| Volume average particle diameter of polyester resin | 267 nm |
| particles | |

### <Production of Polyester Resin Particles Water Dispersion 10>

### (1) Preparation of Mixed Liquid

The following materials were heat melted at 130° C. to form homogeneous “mixed solution 10”.

| | |
|---|---|
| (1 mole ethylene oxide)bisphenol A | 105 g |
| 1,4-cyclohexanedicarboxylic acid | 96 g |
| Scandium(III) triflate | 82 g |

### (2) Preparation of Emulsified Dispersion Liquid

Emulsified dispersion liquid 10 was prepared in the same manner as the preparation of the emulsified dispersion liquid 9.

### (3) Polycondensation of Emulsified Dispersion Liquid

Polyester resin particles water dispersion 10 was produced in the same manner as the production of the polyester resin particles water dispersion 2 except that the emulsified dispersion liquid 2 used in the production of polyester resin particles water dispersion 2 was changed to above mentioned emulsified dispersion liquid 10. The weight average molecular weight of the obtained polyester resin, the melting point, and the volume average particle diameter were measured.

| | |
|---|---|
| Weight average molecular weight of polyester resin | 17,500 |
| Tg of polyester resin | 55° C. |
| Volume average particle diameter of polyester resin | 297 nm |
| particles | |

### <Production of Polyester Resin Particles Water Dispersion 11>

Polyester resin particles water dispersion 11 was produced by using a polycondensation reaction apparatus in which the polycondensation apparatus illustrated in FIG. 2 was modified by replacing the microwave generator with a heating device, and by heating the emulsified dispersion liquid which was the same as used in the production of polyester resin particles water dispersion 1 with the heating device to maintain the temperature at 80° C. for 10 hours. The weight average molecular weight of the obtained polyester resin, the melting point, and the volume average particle diameter were measured in the same way.

| | |
|---|---|
| Weight average molecular weight of polyester resin | 9,980 |
| Melting point of polyester resin | 67° C. |
| Volume average particle diameter of polyester resin | 285 nm |
| particles | |

It took finally 36 hours to obtain a water dispersion of a desired amount of polyester resin particles (150 g) by repeating these procedures 3 times including the procedure for change over, for example, washing the vessel.

### <Production of Polyester Resin Particles Water Dispersion 12>

Polyester resin particles water dispersion 12 was produced by using a polycondensation reaction apparatus for circulate processing in which the polycondensation apparatus illustrated in FIG. 3 was modified by replacing the microwave generator with a heating device, and by heating the emulsified dispersion liquid which was the same as used in the production of polyester resin particles water dispersion 2 with the heating device to maintain the temperature at 80° C. for 30 hours.

The weight average molecular weight of the obtained polyester resin, the melting point, and the volume average particle diameter were measured in the same way.

| | |
|---|---|
| Weight average molecular weight of polyester resin | 10,200 |
| Melting point of polyester resin | 67° C. |
| Volume average particle diameter of polyester resin | 290 nm |
| particles | |

### <Production of Polyester Resin Particles Water Dispersion 13>

### (1) Preparation of Mixed Liquid

The following materials were heat melted at 130° C. to form homogeneous mixed solution 13.

| | |
|---|---|
| 1,9-nonane diol | 66 g |
| 1,10-decanedicarboxylic acid | 96 g |
| Bis (tetrabutyl tin) oxide | 5.1 g |

### (2) Preparation of Emulsified Dispersion Liquid

Six hundreds grams of pure water was kept in a thermostat oven to keep warming at 95° C. Then, the mixed liquid 13 was mixed while the pure water was further agitated. Ultrasound was applied to the mixed liquid using an ultrasonic homogenizer (produced by NIPPON SEIKI Co., Ltd.) to prepare emulsified dispersion liquid 13.

### (3) Polycondensation of Emulsified Dispersion Liquid

In the polycondensation apparatus for circulate processing illustrated in FIG. 3, the above prepared emulsified dispersion liquid 13 was charged and a polycondensation reaction was carried out under the following condition.

### Setting Conditions

| | | |
|---|---|---|
| Inner diameter | 5 | mm |
| Length | 10 | m |
| Amount of circulating liquid | 20 | ml/nim |
| Maximum intensity of microwave irradiation | 10 | W/cm³ |
| Magnetron frequency of microwave | 2450 | MHz |
| Polymerization temperature | 95° | C. |
| Reaction time | 100 | hours |

After the 100 hours reaction, the emulsified dispersion liquid was visually observed, however, the polycondensation reaction was found not to be proceeded.

The materials of the water dispersions of the polyester resin particles are shown in Table 1, the producing conditions of the water dispersions of the polyester resin particles (namely, polyester resin particles dispersions) are shown in Table 2, and the properties of the obtained polyester resins are shown in Table 3.

TABLE 1

| Polyester resin particles | | | | Crystalline |
|---|---|---|---|---|
| water dispersion | Diol | Dicarboxylic acid | Catalyst | compound |
| Polyester resin particles | 1,9-nonanediol | 1,10-decanedicarboxylic acid | Dodecylbenzenesulfonic acid | — |
| water dispersion 1 | | | | |
| Polyester resin particles | 1,9-nonanediol | 1,10-decanedicarboxylic acid | Dodecylbenzenesulfonic acid | — |
| water dispersion 2 | | | | |
| Polyester resin particles | 1,9-nonanediol | 1,10-decanedicarboxylic acid | Dodecylbenzenesulfonic acid | — |
| water dispersion 3 | | | | |
| Polyester resin particles | 1,9-nonanediol | 1,10-decanedicarboxylic acid | Dodecylbenzenesulfonic acid | |
| water dispersion 4 | | | | |
| Polyester resin particles | 1,12-dodecane diol | Azelaic acid | Dodecylbenzenesulfonic acid | — |
| water dispersion 5 | | | | |
| Polyester resin particles | 1,9-nonanediol | 1,10-decanedicarboxylic acid | p-toluenesulfonic acid | — |
| water dispersion 6 | | | | |
| Polyester resin particles | 1,9-nonanediol | 1,10-decanedicarboxylic acid | Dodecylbenzenesulfonic acid | Behenyl |
| water dispersion 7 | | | | behenate |
| Polyester resin particles | (1 mole ethylene | 1,4-cyclohexanedicarboxylic acid | Dodecylbenzenesulfonic acid | |
| water dispersion 8 | oxide)bisphenol A | | | |
| Polyester resin particles | (1 mole ethylene | 1,4-cyclohexanedicarboxylic acid | Scandium(III) triflimide | |
| water dispersion 9 | oxide)bisphenol A | | | |
| Polyester resin particles | (1 mole ethylene | 1,4-cyclohexanedicarboxylic acid | Scandium(III) triflate | |
| water dispersion 10 | oxide)bisphenol A | | | |
| Polyester resin particles | 1,9-nonanediol | 1,10-decanedicarboxylic acid | Dodecylbenzenesulfonic acid | — |
| water dispersion 11 | | | | |
| Polyester resin particles | 1,9-nonanediol | 1,10-decanedicarboxylic acid | Dodecylbenzenesulfonic acid | — |
| water dispersion 12 | | | | |
| Polyester resin particles | 1,9-nonanediol | 1,10-decanedicarboxylic acid | Bis(tributyltin)oxide | — |
| water dispersion 13 | | | | |

TABLE 2

| | Production apparatus | | | | |
|---|---|---|---|---|---|
| | | Maximum | | | |
| | | intensity of | | | |
| | | microwave | Reaction | | |
| Polyester resin particles | | irradiation | temperature | Production | |
| water dispersion | | (W/cm³) | (° C.) | time (hour) | Remarks |
| Polyester resin particles | FIG. 2 (batch | 10 | 80 | 14 | |
| water dispersion 1 | processing) | | | | |
| Polyester resin particles | FIG. 3 (circulation | 10 | 80 | 9 | |
| water dispersion 2 | processing) | | | | |
| Polyester resin particles | FIG. 3 (circulation | 1 | 80 | 9 | |
| water dispersion 3 | processing) | | | | |
| Polyester resin particles | FIG. 3 (circulation | 50 | 80 | 9 | |
| water dispersion 4 | processing) | | | | |
| Polyester resin particles | FIG. 3 (circulation | 10 | 80 | 9 | |
| water dispersion 5 | processing) | | | | |
| Polyester resin particles | FIG. 3 (circulation | 10 | 80 | 9 | |
| water dispersion 6 | processing) | | | | |
| Polyester resin particles | FIG. 3 (circulation | 10 | 80 | 9 | |
| water dispersion 7 | processing) | | | | |
| Polyester resin particles | FIG. 3 (circulation | 10 | 80 | 9 | |
| water dispersion 8 | processing) | | | | |
| Polyester resin particles | FIG. 3 (circulation | 10 | 80 | 9 | |
| water dispersion 9 | processing) | | | | |
| Polyester resin particles | FIG. 3 (circulation | 10 | 80 | 9 | |
| water dispersion 10 | processing) | | | | |
| Polyester resin particles | FIG. 2 (batch | — | 80 | 36 | |
| water dispersion 11 | processing) | | | | |
| Polyester resin particles | FIG. 3 (circulation | — | 80 | 30 | |
| water dispersion 12 | processing) | | | | |
| Polyester resin particles | FIG. 3 (circulation | 10 | 95 | — | *1 |
| water dispersion 13 | processing) | | | | |

*1: No polymerization was observed.

TABLE 3

| | | Resin properties | | | |
|---|---|---|---|---|---|
| | | Molecular | | | Volume average |
| | Polyester resin particles | weight | | Melting | particle diameter |
| | water dispersion | (Mw) | Mw/Mn | point | (nm) |
| Example 1 | Polyester resin particles | 12500 | 2.8 | 68 | 310 |
| | water dispersion 1 | | | | |
| Example 2 | Polyester resin particles | 11600 | 2.6 | 68 | 298 |
| | water dispersion 2 | | | | |
| Example 3 | Polyester resin particles | 10200 | 2.6 | 67 | 308 |
| | water dispersion 3 | | | | |
| Example 4 | Polyester resin particles | 11200 | 2.9 | 67 | 304 |
| | water dispersion 4 | | | | |
| Example 5 | Polyester resin particles | 10030 | 2.6 | 66 | 324 |
| | water dispersion 5 | | | | |
| Example 6 | Polyester resin particles | 9800 | 2.5 | 67 | 288 |
| | water dispersion 6 | | | | |
| Example 7 | Polyester resin particles | 11180 | 2.7 | 66 | 332 |
| | water dispersion 7 | | | | |
| Example 8 | Polyester resin particles | 15800 | 2.5 | — | 287 |
| | water dispersion 8 | | | | |
| Example 9 | Polyester resin particles | 13500 | 2.7 | — | 267 |
| | water dispersion 9 | | | | |
| Example 10 | Polyester resin particles | 17500 | 2.6 | — | 297 |
| | water dispersion 10 | | | | |
| Comparative | Polyester resin particles | 9980 | 2.6 | 67 | 285 |
| example 1 | water dispersion 11 | | | | |
| Comparative | Polyester resin particles | 10020 | 2.7 | 67 | 290 |
| example 2 | water dispersion 12 | | | | |
| Comparative | Polyester resin particles | — | — | — | — |
| example 3 | water dispersion 13 | | | | |

The results shown in Tables 1-3 demonstrates that the polyester resin particles 1-10 have achieved one of the objects of the present invention, namely, to produce a polyester rein particles water dispersion at a low temperature, in a short time and with a high thermal efficiency.

On the other hand, it is also demonstrated that the polyester resin particles 11-13 which are comparative Examples failed to achieved one of the objects of the present invention, namely, to produce a polyester rein particles water dispersion at a low temperature, in a short time and with a high thermal efficiency.

### <<Resin Composition>>

The resin composition was produced as follows.

### (Production of Resin Composition 1)

In 1150 mass parts of pure water, 390 mass parts of a 0.1 mol/L aqueous solution of Na₃PO₄ was fed and the solution was stirred using CLEAMIX (produced by M Technique Co., Ltd.) at 10,000 rpm. Into this solution, 58 mass parts of a 1.0 mol/L aqueous solution of CaCl₂ was gradually added to obtain a dispersion liquid containing Ca₃(PO₄)₂.

Next, a polymerizable monomer composition was prepared by mixing and dissolving the following compounds.

| | | |
|---|---|---|
| Polyester resin particles | 100 | mass parts (in solid content) |
| water dispersion 1 | | |
| Styrene | 80 | mass parts |
| N-butyl acrylate | 20 | mass parts |
| 2,2-azobis(2,4-dimethyl | 2.7 | mass parts |
| baleronitrile) | | |

A dispersion of a polymerizable monomer composition in which droplets the polymerizable monomer composition was dispersed was prepared by adding the above materials into the above dispersion which was stirred by CLEAMIX at 6000 rpm and by further stirring for 20 minutes.

The dispersion of this composition was charged in a reaction vessel equipped with a stirrer, a temperature sensor, a cooling tube and a tube for nitrogen inlet, and a polymerization treatment was conducted for 5 hours under a nitrogen gas flow by increasing the inside temperature of the reaction vessel at 60° C. The polymerization treatment was further conducted for 5 hours by increasing the inside temperature at 80° C., and then the reaction vessel was cooled to an ambient temperature. The obtained dispersion liquid was designated as resin composition dispersion liquid 1. After dissolving Ca₃(PO₄)₂ by adding hydrochloric acid to the resin composition dispersion liquid 1, treatments of washing, filtering and drying were conducted, whereby resin composition 1 was obtained. The weight average molecular weight Mw and the number average molecular weight Mn of the resin composition 1 were 29,900 and 32,000, respectively.

### (Production of Resin Compositions 2-10)

Resin compositions 2-10 were prepared in the same manner as the preparation of the above resin composition 1 except that the polyester resin particles water dispersion 1 used in the preparation of the resin composition 1 was replaced with polyester resin particles water dispersions 2-10, respectively.

### <<Production of Electrophotographic Toner>>

A toner was produced as follows.

### (Production of Toner 1)

### <Preparation of Wax Dispersion Liquid>

In 30 ml of ion exchanged water, 1.0 mass part of sodium dodecybenzenesulfonate being an anionic surfactant was dissolved while being stirred. This solution was heated to 90° C., gradually added with 7 mass parts of a melt of behenyl behenate (melting point: 70° C.) obtained by heating at 90° C., while this solution was stirred. Subsequently, the resultant solution was subjected to a dispersion treatment at 90° C. for 7 hours using a mechanical disperser CLEAMIX (produced by M Technique Co., Ltd.) and then cooled to 30° C., whereby a dispersion liquid of wax (hereafter, also referred to as wax dispersion liquid (1)) was prepared. The volume median diameter (D₅₀) of the wax particles in the obtained wax dispersion (1) was determined to be 95 nm using an electrophoresis light-scattering photometer ELS-800 (produced by OTSUKA ELECTRONICS Co., Ltd.).

### (Preparation of Colorant Dispersion Liquid)

In 30 ml of ion exchanged water, 1.0 mass part of sodium dodecybenzenesulfonate being an anionic surfactant was dissolved while being stirred. This solution was gradually added with 7 g of C.I. Pigment Blue 15:3, while this solution was stirred. Subsequently, the resultant solution was subjected to a dispersion treatment using a mechanical disperser CLEAMIX (produced by M Technique Co., Ltd.) and then cooled to 30° C., whereby a dispersion liquid of colorant (hereafter, also referred to as a colorant dispersion liquid) was prepared. The volume average particle diameter (an average particle diameter weighted by volume) of the colorant particles in the obtained colorant dispersion was determined to be 92 nm using a microtrack UPA particle size distribution analyzer 9340-UPA (produced by HONEYWELL).

### <Production of Coloring Particles>

A dispersion liquid of resin composition 1 (100 mass parts in solid content), 400 mass parts of ion exchanged water, the colorant dispersion liquid (8 mass parts in solid content) and the wax dispersion liquid (6 mass parts in solid content) were charged in a reaction vessel equipped with a stirrer, a temperature sensor, a cooling tube and a tube for nitrogen inlet. The inside temperature of the reaction vessel was controlled at 3° C. and the pH value of the dispersion liquid for aggregation was adjusted at 10.0 using a 5 N sodium hydroxide aqueous solution. Subsequently, an aqueous solution prepared by dissolving 1 mass part of magnesium chloride, hexahydrate in 20 ml of ion exchanged water was added dropwise while the liquid was stirred. After the resultant liquid was left for 1 minute, the temperature was started raising and increased to 90° C. in 10 minutes. A stirring device was used for stirring.

At this state, the particle diameters of the aggregated particles were measured using a flow-type particle image analyzer FPIA2000 (produced by SYSMEX Corp.), and, when the number median diameter (D₅₀) reached 5.2 μm, the growth of particles was stopped by adding an aqueous solution in which 2 mass parts of sodium chloride was dissolved in 20 ml of ion exchanged water. The resultant liquid was further stirred while heating at 95° C. for 10 hours to control the particle shape by continuing the fusion, followed by cooling to 30° C. Then, hydrochloric acid was added to adjust the pH value at 2.0 and stirring was stopped.

The formed particles were filtered, repeatedly washed with 45° C. ion exchanged water, and dried with warm wind of 40° C., whereby colored particles were obtained.

### <Production of Toner 1>

To 100 mass parts of the colored particles, 1.0 mass part of silica particles having a number average primary particle diameter of 12 nm and a hydrophobicity of 80 and 1.0 mass part of titania particles having a number average primary particle diameter of 25 nm and a hydrophobicity of 80 were added and mixed using a HENSCHEL mixer, whereby toner 1 having a number median diameter (1)₅₀) of 5.2 μm was obtained.

The shape and the diameter of the colored particles constituting the toner did not change by the addition of the external additive.

### (Production of Toners 2-6 and 8-10)

Toners 2-6 and 8-10 were produced in the same manner as the production of toner 1 except that the dispersion liquid of resin composition 1 was changed to the dispersion liquids of resin compositions 2-6 and 8-10, respectively.

### (Production of Toner 7)

Toner 7 was produced in the same manner as the production of toner 1 except that the dispersion liquid of resin composition 1 was changed to the dispersion liquid of resin composition 6 (containing behenyl behenate), and the dispersion liquid pg the crystalline compound used in the production of toner 1 was not added.

### <Evaluation of Toner>

The produced toners were sequentially charged in a copier bizhub C500 (produced by Konica Minolta Business Technologies, Inc.) and evaluated in terms of a low temperature fixing property.

### (Low Temperature Fixing Property)

The surface temperature of a heating roller of the apparatus for image evaluation (the temperature was measured at the center of the roller) was varied at intervals 5° C. in the range of 90 to 130° C. At the respective surface temperatures, an A4-sized image, carrying a 5 mm wide, solid belt-kike image of cyan which was arranged vertically to the conveyance direction was longitudinally conveyed to be fixed; then, an A4 image having a 5 mm wide, solid black belt-like image and a 20 mm wide halftone image which were arranged vertically to the conveyance direction was laterally conveyed and fixed. The temperature range in which image staining due to fixing offset did not occur (also referred to as a non-offset temperature range) was evaluated.

As the results of evaluation, the toners 1-10 produced by employing the resin compositions 1-10 of the present invention exhibited a lower limit temperature of the non-offset temperature range of 110° C. or less and a non-offset temperature range wider than 15° C., showing that these toner had excellent low temperature fixing properties.

What is claimed is:

1. A method of producing a water dispersion of polyester resin particles comprising the steps of:
emulsifying and dispersing at least a diol, a dicarboxylic acid and at least one polycondensation catalyst selected from a surfactant catalyst and a rare earth metal catalyst in water to form an emulsified dispersion liquid; and
irradiating the emulsified dispersion liquid with a microwave to conduct a polycondensation reaction, whereby polyester resin particles are produced.

2. The method of claim 1, wherein the emulsified dispersion liquid is irradiated with the microwave while the emulsified dispersion liquid is circulated.

3. The method of claim 1, wherein an irradiation power of the microwave is 0.1 to 500 W/cm³.

4. The method of claim 1, wherein the emulsified dispersion liquid contains a crystalline compound having a melting point of 50 to 95° C.

5. The method of claim 1, wherein the polycondensation catalyst is the surfactant catalyst.

6. The method of claim 1, wherein the polyester particles have a glass transition temperature of 25-90° C.

7. The method of claim 1, wherein the polyester resin particles comprise a non-crystalline polyester.

8. The method of claim 1, wherein the polyester resin particles comprise a crystalline polyester.

9. A resin composition produced by employing the polyester resin particles produced by the method of claim 1.

10. A method of producing a resin composition comprising the steps of:
adding a radically polymerizable monomer into the water dispersion of the polyester resin particles produced by the method of claim 1; and
polymerizing the radically polymerizable monomer via seeded polymerization employing the polyester resin particles as seeds to cover surfaces of the polyester resin particles, followed by separating the obtained polyester resin particles from the water dispersion.

11. A resin composition produced by the method of claim 10.

12. An electrophotographic toner comprising particles formed by aggregating and fusing the resin composition of claim 9 and a colorant under existence of an aggregating agent.

13. A method of producing a water dispersion of polyester resin particles comprising the steps of:
emulsifying and dispersing at least an aliphatic diol and an aliphatic dicarboxylic acid in water containing a surfactant catalyst to form an emulsified dispersion liquid; and
irradiating the emulsified dispersion liquid with a microwave to conduct a polycondensation reaction, whereby polyester resin particles are produced.
